(19) United States
(12) Patent Application Publication
(10) Pub. No.: US 2011/0264262 A1
(43) Pub. Date: Oct. 27, 2011

(54) TRANSACTIONAL-BASED VENDING MACHINE SOLUTION FOR SCHOOLS

(76) Inventor: Samuel Van Gucht, Merchtem (BE)

(21) Appl. No.: 12/766,941

(22) Filed: Apr. 26, 2010

(51) Int. Cl. G06F 17/00

(52) U.S. Cl. 700/232

(57) ABSTRACT

The vending solution will provide healthy food in schools and will help schools to increase their participation in the National School Lunch and School breakfast Program The schools do not need to invest in expensive technology or extend their traditional serving line.

### FIELD OF THE INVENTION

This invention relates generally to a transactional-based vending machine solution for schools.

### DESCRIPTION OF THE BACKGROUND ART

Schools are in need for a vending solution that will help them feed more kids who are struggling to pay for a meal. Schools have the ability to receive government aid per student per meal per day. But the technology, solution that will help them give more meals to these students is expensive and not an option due to budget constraints. Cafeterias are also expensive and do not reach the total audience in the small time frame We would offer schools the technology without payment upfront so that schools can utilize the government aid.

### SUMMARY

The vending solution will provide healthy food in schools and will help schools to increase their participation in the National School Lunch and School Breakfast Program The schools do not need to invest in expensive technology or extend their traditional serving line.

### DETAILED DESCRIPTION OF THE PREFERRED EMBODIMENTS

The vending solution will provide healthy food in schools and will help schools to increase their participation in the National School Lunch and School breakfast Program The schools do not need to invest in expensive technology or extend their traditional serving line.

The vending solution works with most Point of Sale systems to serve healthy, school cafeteria prepared, USDA compliant meals in approximately 20 seconds per child.

For optimal results, the machine has to be put in locations where most students find it “cool” and easy to eat healthy meals.

The solution we offer are targeted to Public schools where the need for Free Lunch and Breakfast meals is the highest because the meals are paid by the government. The schools and students themselves do not need to pay for the meals and distribution of it.

The schools do not need to pay for the machine either as we only charge a one time installation fee of $1,000 and a transaction fee per transaction which is covered by the National School Lunch and School breakfast Program.

In general, having vending machines to offer healthy meals in the schools at strategic places will increase the meal consumption by 25%.

By giving the schools the option to have the machine for free but to include us in the profit sharing, we help overcome their budget constrains and other obstacles to give it a try.

The meal income of the schools will rise and the cost of the handling will drop.

The servicing of the vending machine, when there is a malfunction, is handled by a service team and a toll free tech support number is available to answer questions.

There is also a telemetry solution in the machine that communicates to the service computer so all handling in the machine, transactions and malfunctions are monitored in detail. This communication goes over the cell phone network, so the solution can be installed anywhere where there is cell phone coverage.

A normal phone connection is also available when needed.

The schools are in charge of the food that goes into the vending solution. Their current food service provider can fill up the solution for them.

The schools need to make sure that the meals provided in the machine include all the components required by the NSLBP.

The solution will shut down if the temperature would drop too much. Dropping of temperature will also alarm the technical service company.

The cleaning of the vending solution is done by the school and would take a couple minutes daily and a weekly check is done in 10 minutes.

Less handling is needed than the traditional service line.

The vending solution follows a real eco-concept path: life cycle analysis, reduction of energy consumption (filling up without opening the front door, etc.), use of raw material with reduced environmental impact and low cost end of life disassembly.

The students have the ability to get their daily meal during the lunch time from 10 am till 13 pm. The time to get a meal from the machine is on average 17-20 seconds, much faster than other vending machines and traditional cafeteria lines.

It is not necessary that the telemetric system/computer of the vending machine(s) communicates with the POS or communicates with the server of the owner/exploitant of the vending machine

It is also possible that there is no per serving transactional payment but only a monthly fee

What is claimed is:

1. The method, system, process and vending machine
whereby one or more food vending machines are placed/implemented at schools
And whereby there is a transactional payment system on a per serving basis
And whereby there is a communication between the telemetric system/computer of the vending machine(s) and a) the point of sale solution of the schools and/or with b) the server of the owner/exploitant of the vending machine(s)
And whereby there is a financial payment agreement based on a transactional model on a per serving basis between the owner/exploitant of the vending machines with the schools
And whereby schools do not have to own/lease the vending machine(s) but pay on a (monthly) transactional rent basis for each serving of food in each vending machine with the owner/exploitant of the vending machine(s)

2. Any variation of the method, system, process and vending machine of claim 1 wherein the telemetric system/computer of the vending machine(s) does not communicate with the POS or does not communicate with the server of the owner/exploitant of the vending machine

3. Any variation of the method, system, process and vending machine of claim 1 wherein there is no per serving transactional payment but only a monthly fee
